(19) United States
(12) Patent Application Publication
(10) Pub. No.: US 2025/0199533 A1
(43) Pub. Date: Jun. 19, 2025

(54) MANAGEMENT SYSTEM

(71) Applicant: TOYOTA JIDOSHA KABUSHIKI KAISHA, Tayota-shi (JP)

(72) Inventors: Yuki SUEHIRO, Susono-shi (JP); Shuichi TAMAGAWA, Kitanagoya-shi (JP)

(73) Assignee: TOYOTA JIDOSHA KABUSHIKI KAISHA, Tayota-shi (JP)

(21) Appl. No.: 18/912,584

(22) Filed: Oct. 11, 2024

(30) Foreign Application Priority Data
Dec. 18, 2023 (JP) 2023-212959

(51) Int. Cl. G05D 1/227; G05D 109/10; G06F 21/31

(52) U.S. Cl. CPC G05D 1/2279; G06F 21/31; G05D 2109/10

(57) ABSTRACT

A remote operator outside the remote operation management center is an external operator. An external operator terminal is used by the external operator for a remote operation. A management system acquires at least one of license information indicating a license held by the external operator and terminal specification information indicating a specification of the external operator terminal. The management system extracts, as a requestable candidate, a remote operation request that is supportable by at least one of the license of the external operator and the specification of the external operator terminal from a remote operation request list. The management system transmits information on one or more requestable candidates to the external operator terminal before the external operator is assigned to any of the remote operation requests.

### CROSS-REFERENCE TO RELATED APPLICATION

This application claims priority to Japanese Patent Application No. 2023-212959 filed on Dec. 18, 2023. The disclosure of the above-identified application, including the specification, drawings, and claims, is incorporated by reference herein in its entirety.

### BACKGROUND

### 1. Technical Field

The present disclosure relates to a remote operation of a mobility.

### 2. Description of Related Art

Japanese Unexamined Patent Application Publication No. 2020-42764 (JP 2020-42764 A) discloses a vehicle remote operation assistance system. In a case where the number of operators is insufficient, the vehicle remote operation assistance system requests remote operation assistance from an external operator within an external center separated from a control center.

### SUMMARY

According to the technology described in JP 2020-42764 A, the system makes a unilateral request to the external operator, and there is thus no room for the external operator to make a selection. There is a concern that the external operator is forced to perform unintended remote operation assistance. As a result, there is a concern that accuracy of the remote operation assistance decreases.

A first aspect of the disclosure relates to a management system that is installed in a remote operation management center for managing a remote operation of a mobility. A remote operator outside the remote operation management center is an external operator. A remote operator terminal configured to be used by the external operator for the remote operation is an external operator terminal. The management system includes: one or more processors; and one or more storage devices configured to store a remote operation request list including one or more remote operation requests. The one or more processors are configured to acquire at least one of license information indicating a license held by the external operator and terminal specification information indicating a specification of the external operator terminal. The one or more processors are configured to extract, as a requestable candidate, a remote operation request that is supportable by at least one of the license of the external operator and the specification of the external operator terminal from the remote operation request list. The one or more processors are configured to transmit information on one or more requestable candidates to the external operator terminal before the external operator is assigned to any of the remote operation requests.

According to the present disclosure, the requestable candidate is presented to the external operator before the external operator is assigned to the remote operation request. Since the external operator can select a desired remote operation request by himself/herself, accuracy of the remote operation is secured.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram for describing an overview of a remote operation system;

FIG. 2 is a conceptual diagram showing a configuration example of the remote operation system;

FIG. 3 is a conceptual diagram for describing an overview of an assignment process;

FIG. 4 is a block diagram for describing an example of extraction of a requestable candidate;

FIG. 5 is a diagram showing a first example of a process flow related to an external operator assignment process; and

FIG. 6 is a diagram showing a second example of the process flow related to the external operator assignment process.

### DETAILED DESCRIPTION OF EMBODIMENTS

### 1. Remote Support System

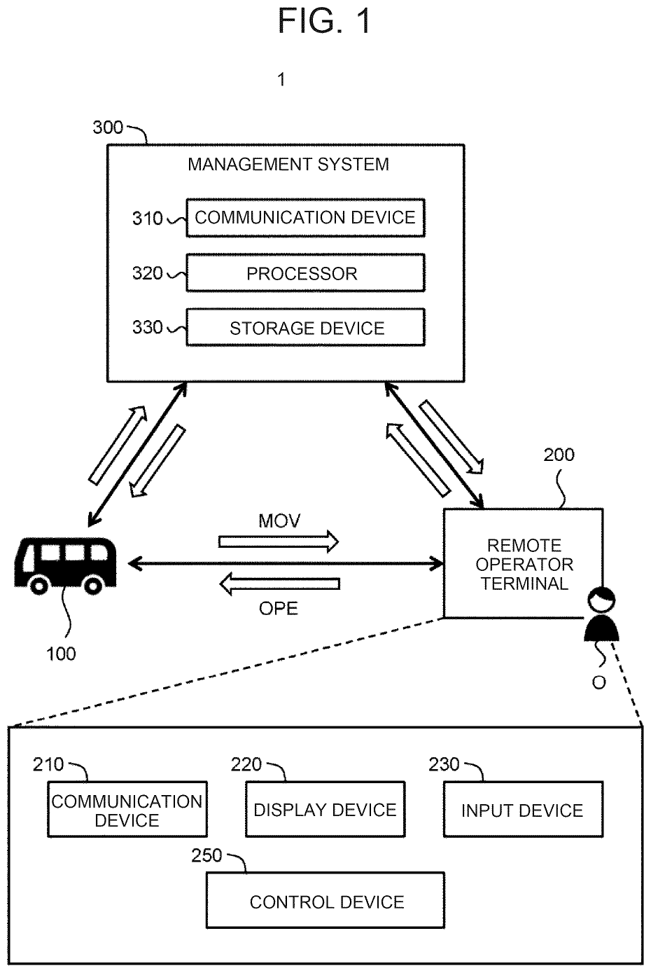

FIG. 1 is a conceptual diagram for describing an overview of a remote operation system 1 according to the present embodiment. The remote operation system 1 is a system for a remote operation of a mobility 100. The remote operation is a concept including remote driving. The remote operation system 1 includes the mobility 100, a remote operator terminal 200, and a management system 300. The mobility 100, the remote operator terminal 200, and the management system 300 can communicate with each other via a communication network. For example, the mobility 100 can wirelessly communicate with the remote operator terminal 200 and the management system 300 via a wireless communication network. The remote operator terminal 200 and the management system 300 can communicate with each other via a wired/wireless communication network.

### 1-1. Mobility

The mobility 100 is a mobile object that is movable. The mobility 100 may be manually operated by an operator aboard the mobility 100. The mobility 100 may include an autonomous movement function. In either case, the mobility 100 is configured to be operated remotely as needed. That is, the mobility 100 is a target of the remote operation by the remote operation system 1.

A kind of the mobility 100 as the target of the remote operation is not limited to one, and may be two or more. For example, the mobility 100 is a vehicle that travels on a public road. As another example, the mobility 100 may be a vehicle used in a factory. As further another example, the mobility 100 may be a specialized small vehicle. As further another example, the mobility 100 may be a construction machine. As further another example, the mobility 100 may be a robot. As further another example, the mobility 100 may be a flying object. As further another example, the mobility 100 may be a ship. As further another example, the mobility 100 may be a ride in an amusement park.

### 1-2. Remote Operator Terminal

The remote operator terminal 200 is a terminal device used when a remote operator O remotely operates the mobility 100. That is, the remote operator terminal 200 is configured to be used by the remote operator O for the remote operation of the mobility 100. Examples of the remote operator terminal 200 include a cockpit-type terminal, a PC, a tablet, and a smartphone. The single remote operator terminal 200 may be configured to support remote operations of various kinds of mobility 100.

The remote operator terminal 200 includes a communication device 210, a display device 220, an input device 230, and a control device 250.

The communication device 210 communicates with the mobility 100 and the management system 300.

The display device 220 displays various kinds of information to the remote operator O who performs the remote operation. In other words, the display device 220 presents various kinds of information to the remote operator O by displaying various kinds of information. Examples of the display device 220 include a display and a touch panel.

The input device 230 receives an input from the remote operator O. For example, the input device 230 includes a remote operation member that is operated when the remote operator O remotely operates the mobility 100. Examples of the remote operation member include a steering wheel, an accelerator pedal, a brake pedal, a joystick, a directional pad, and a switch. The remote operation member may be a touch panel. The input device 230 may include an information input unit other than the remote operation member.

The control device 250 controls the remote operator terminal 200. The control device includes one or more processors and one or more storage devices. The processor executes various processes. Examples of the processor include a CPU, a GPU, an ASIC, and an FPGA. The processor may also be referred to as a circuitry or a processing circuitry. The storage device stores various kinds of information. Examples of the storage device include a volatile memory, a non-volatile memory, an HDD, and an SSD. Functions of the control device 250 may be implemented by cooperation of the processor executing control programs and the storage device. The control programs are stored in the storage device. Alternatively, the control programs may be recorded on a computer-readable recording medium.

### 1-3. Management System (Manager)

The management system 300 is a computer that manages the remote operation system 1. The management system 300 may be constituted by a plurality of servers that performs distributed processing. The management system 300 manages a plurality of remote operators O and a plurality of remote operator terminals 200.

The management system 300 includes a communication device 310, one or more processors 320 (hereinafter, simply referred to as the processor 320), and one or more storage devices 330 (hereinafter, simply referred to as the storage device 330). The communication device 310 communicates with the mobility 100 and the remote operator terminal 200.

The processor 320 executes various processes. Examples of the processor 320 include a general-purpose processor, an application-specific processor, a CPU, a GPU, an ASIC, an FPGA, an integrated circuit, a circuit in the related art, or combinations thereof. The processor 320 may also be referred to as a circuitry or a processing circuitry. The circuitry is hardware programmed to implement described functions, or hardware that performs the functions. The storage device 330 stores various kinds of information. Examples of the storage device 330 include a volatile memory, a non-volatile memory, an HDD, and an SSD. Functions of the management system 300 may be implemented by cooperation of the processor 320 executing management programs and the storage device 330. The management programs are stored in the storage device 330. Alternatively, the management programs may be recorded on a computer-readable recording medium. The management programs may be provided via a network.

Before the start of the remote operation of the mobility 100, the processor 320 executes an “assignment process” of assigning an appropriate remote operator O and an appropriate remote operator terminal 200 for the remote operation of the mobility 100. Details of the assignment process will be described later.

### 1-4. Flow of Information During Remote Operation

The mobility 100 is equipped with various sensors including a camera. The camera captures a situation around the mobility 100. An image showing the situation around the mobility 100 is obtained by the camera. Mobility information MOV is information obtained by various sensors, and includes at least the image captured by the camera. The mobility information MOV may include a location and a status of the mobility 100 (for example, a velocity and a steering angle). The mobility 100 transmits the mobility information MOV to the remote operator terminal 200.

The remote operator terminal 200 receives the mobility information MOV transmitted from the mobility 100. The remote operator terminal 200 presents the mobility information MOV to the remote operator O. Specifically, the remote operator terminal 200 displays the image or the like on the display device 220. The remote operator O looks at the displayed information, recognizes the situation around the mobility 100, and remotely operates the mobility 100. Specifically, the remote operator O operates the remote operation member of the input device 230. An operation amount of the remote operation member is detected by a sensor installed in the remote operation member. The control device 250 generates remote operation information OPE reflecting the operation amount of the remote operation member by the remote operator O. Then, the control device 250 transmits the remote operation information OPE to the mobility 100 via the communication device 210.

The mobility 100 receives the remote operation information OPE transmitted from the remote operator terminal 200. The mobility 100 performs mobility control in accordance with the received remote operation information OPE. In this way, the remote operation of the mobility 100 is achieved.

### 2. Utilization of External Operator

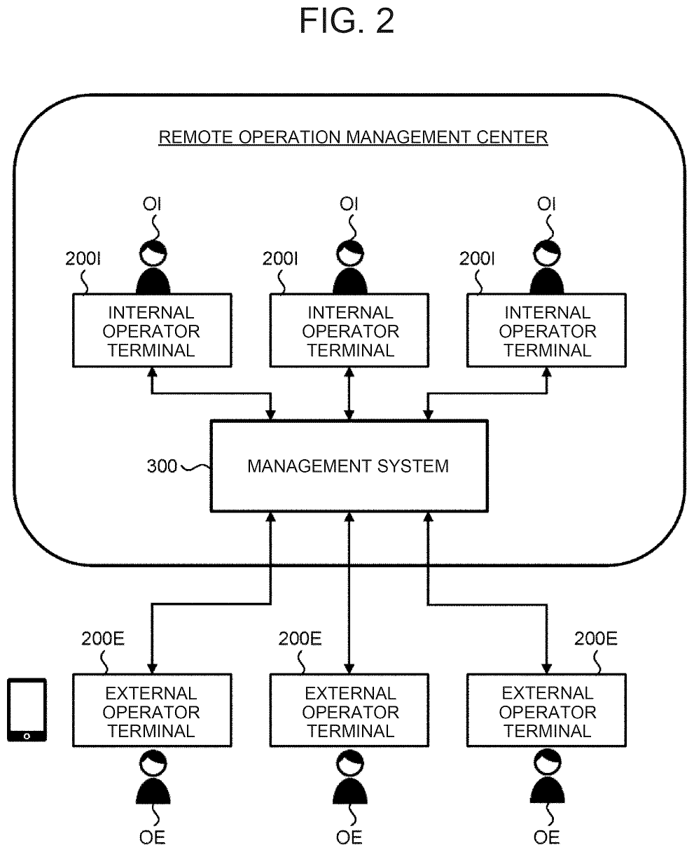

FIG. 2 is a conceptual diagram showing a configuration example of the remote operation system 1. A remote operation management center is a facility for managing the remote operation of the mobility 100. The remote operation management center is provided at a predetermined site or in a predetermined building. The management system 300 is installed in the remote operation management center. According to the present embodiment, the remote operator O and the remote operator terminal 200 are classified into two kinds from the viewpoint of an inside and an outside of the remote operation management center.

An “internal operator OI” is the remote operator O in the remote operation management center. In other words, the internal operator OI is engaged in remote operation service within the remote operation management center. The internal operator OI may be a full-time remote operator O. An “internal operator terminal 2001” is the remote operator terminal 200 used by the internal operator OI for remote operations, and is installed in the remote operation management center. The management system 300 constantly monitors and manages statuses of a plurality of the internal operators OI. Additionally, the management system 300 constantly monitors and manages statuses of a plurality of the internal operator terminals 200I.

On the other hand, an “external operator OE” is the remote operator O outside the remote operation management center. In other words, the external operator OE is engaged in the remote operation services outside the remote operation management center. For example, the external operator OE is engaged in the remote operation services at home. The external operator OE may be a part-time remote operator O. Reliability of the external operator OE may be lower than reliability of the internal operator OI. An “external operator terminal 200E” is the remote operator terminal 200 used by the external operator OE for the remote operation and is present outside the remote operation management center. The management system 300 does not always monitor statuses of a plurality of the external operators OE. The management system 300 may acquire the statuses of the external operators OE at predetermined times (for example, at the time of the assignment process). The management system 300 does not always monitor statuses of the external operator terminals 200E. The management system 300 may acquire the statuses of the external operator terminals 200E at a predetermined timing (for example, at the time of the assignment process).

According to the present embodiment, not only the internal operator OI and the internal operator terminal 200I but also the external operator OE and the external operator terminal 200E are utilized as needed. That is, the management system 300 selects an appropriate external operator OE and an appropriate external operator terminal 200E as needed and assigns the appropriate external operator OE and the appropriate external operator terminal 200E to the remote operation of the mobility 100. The assignment process by the management system 300 will be described in more detail below.

### 3. Assignment Process

### 3-1. Basic Assignment Process

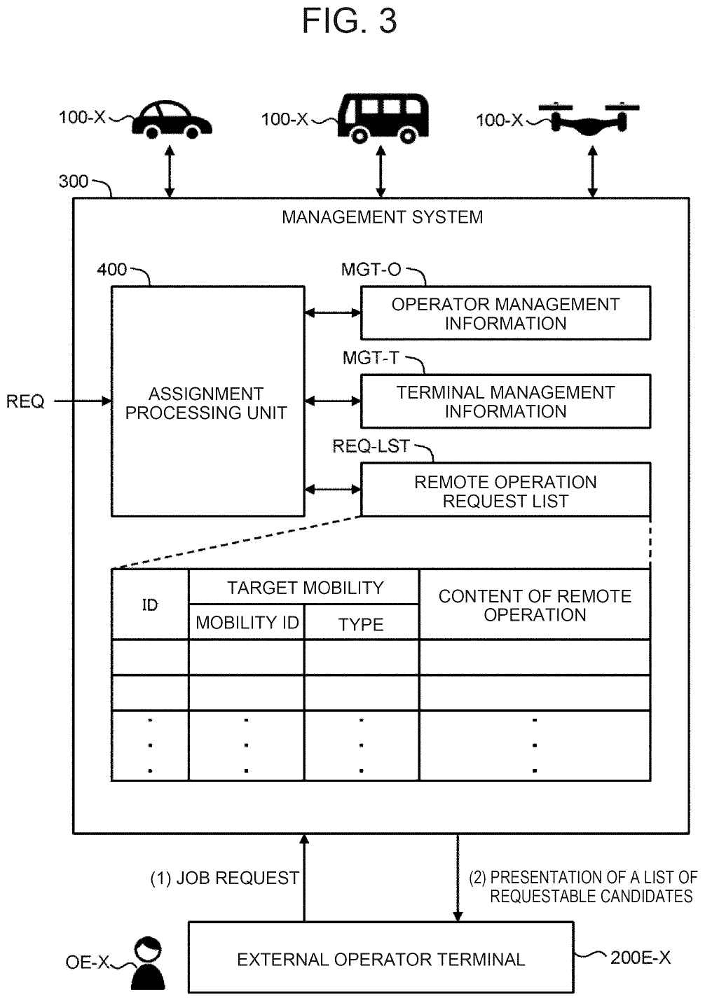

FIG. 3 is a conceptual diagram for describing an overview of the assignment process by the management system 300. The storage device 330 of the management system 300 stores operator management information MGT-O and terminal management information MGT-T. The operator management information MGT-O is information for managing the remote operators O. For example, the operator management information MGT-O indicates, for each remote operator O, an operator ID, licenses held, availability, an assignment status, and work history. The terminal management information MGT-T is information for managing the remote operator terminals 200. For example, the terminal management information MGT-T indicates, for each remote operator terminal 200, a terminal ID, specifications, availability, an assignment status, and movable history.

The management system 300 (processor 320) includes an assignment processing unit 400 that executes the assignment process. First, the assignment processing unit 400 receives a remote operation request REQ regarding a target mobility 100-X, which is the target of the remote operation. For example, the remote operation request REQ is issued from the target mobility 100-X itself. In this case, the target mobility 100-X transmits the remote operation request REQ to the management system 300 via the wireless communication. As another example, the remote operation request REQ may be transmitted to the management system 300 from a service provider affiliated with the remote operation system 1.

The remote operation request REQ indicates a kind of the target mobility 100-X and contents of a desired remote operation. In response to the remote operation request REQ, the assignment processing unit 400 assigns the remote operator O and the remote operator terminal 200 to the remote operation of the target mobility 100-X. More specifically, the assignment processing unit 400 selects an appropriate remote operator O from among the remote operators O based on the remote operation request REQ and the operator management information MGT-O. Additionally, the assignment processing unit 400 selects an appropriate remote operator terminal 200 from among the remote operator terminals 200 based on the remote operation request REQ and the terminal management information MGT-T.

### 3-2. Assignment Process in Consideration of Requests From External Operators

An “external operator assignment process” of assigning the external operator OE to the remote operation of the target mobility 100-X is considered. In a case where the management system 300 unilaterally selects and assigns an external operator OE for a remote operation of a certain target mobility 100-X, that external operator OE has no room to select the target mobility 100-X or contents of the remote operation. In a case where the external operator OE is forced to remotely operate an unintended target mobility 100-X, there is a concern that accuracy of the remote operation decreases.

Therefore, according to the present embodiment, the management system 300 is configured to execute the external operator assignment process in consideration of the request from the external operator OE.

First, the external operator OE requests the management system 300 to arrange a remote operation job for the mobility 100 through the external operator terminal 200E. The external operator OE that makes the request is hereinafter referred to as a “first external operator OE-X”. The external operator terminal 200E used by the first external operator OE-X is hereinafter referred to as a “first external operator terminal 200E-X”. The first external operator terminal 200E-X transmits a job request to the management system 300 in response to an instruction from the first external operator OE-X.

The storage device 330 of the management system 300 stores a “remote operation request list REQ-LST”. The remote operation request list REQ-LST includes one or more remote operation requests REQ that are unassigned. Each remote operation request REQ includes at least one of the kind of the target mobility 100-X and contents of the remote operation of the target mobility 100-X. The remote operation request REQ may include both the kind of the target mobility 100-X and the contents of the remote operation of the target mobility 100-X.

The assignment processing unit 400 of the management system 300 receives the job request transmitted from the first external operator terminal 200E-X. In response to the job request, the assignment processing unit 400 extracts, from the remote operation request list REQ-LST, the remote operation request REQ that can be requested to the first external operator OE-X as a “requestable candidate”.

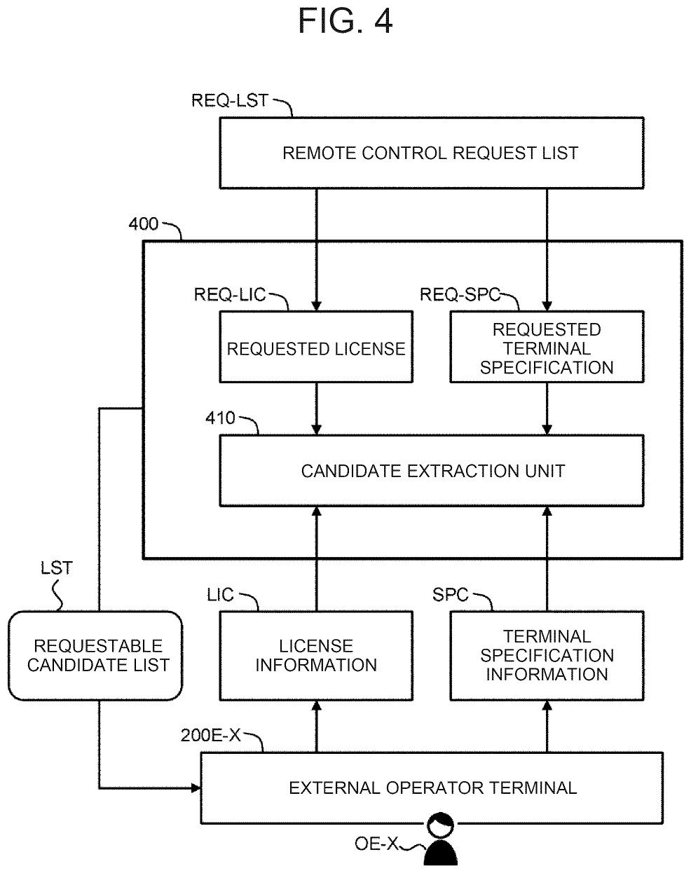

FIG. 4 is a block diagram for describing an example of extraction of the requestable candidate. Regarding the extraction of the requestable candidate, the following first and second aspects can be considered. The assignment processing unit 400 extracts the requestable candidate in consideration of at least one of the first and second aspects. The assignment processing unit 400 may extract the requestable candidate in consideration of both the first and second aspects.

First, the first aspect will be described. The first external operator OE-X holds licenses (qualifications, permits) for one or more kinds of mobility 100. A license for a certain mobility 100 is an official authorization to operate that mobility 100. For example, the first external operator OE-X uses the input device 230 of the first external operator terminal 200E-X to input a license held by the first external operator OE-X. License information LIC indicates the license held by the first external operator OE-X regarding operations of the one or more kinds of mobility 100. The first external operator terminal 200E-X transmits the license information LIC to the management system 300. The management system 300 may register the license information LIC regarding the first external operator OE-X in the operator management information MGT-O.

The assignment processing unit 400 recognizes a “requested license REQ-LIC” needed for the remote operation of the target mobility 100-X regarding each remote operation request REQ included in the remote operation request list REQ-LST. More specifically, the assignment processing unit 400 recognizes the requested license REQ-LIC needed for each remote operation request REQ based on the kind of the target mobility 100-X.

The assignment processing unit 400 includes a candidate extracting unit 410. The candidate extracting unit 410 acquires the license information LIC regarding the first external operator OE-X. For example, the candidate extracting unit 410 acquires the latest license information LIC from the first external operator terminal 200E-X. As another example, the candidate extracting unit 410 may acquire the previous license information LIC registered in the operator management information MGT-O. Additionally, the candidate extracting unit 410 acquires information on the requested license REQ-LIC regarding each remote operation request REQ included in the remote operation request list REQ-LST. Then, the candidate extracting unit 410 extracts, as a requestable candidate, the remote operation request REQ such that the requested license REQ-LIC is included in the license held by the first external operator OE-X. In other words, the candidate extracting unit 410 extracts, as a requestable candidate, the remote operation request REQ that can be supported by the license of the first external operator OE-X from the remote operation request list REQ-LST.

Next, the second aspect will be described. Examples of a kind of the external operator terminal 200E include a cockpit-type terminal, a PC, a tablet, and a smartphone. As the kind of the external operator terminal 200E changes, the kind of the mobility 100 that can be supported and the content of the remote operation that can be supported also change. For example, a vehicle cockpit is suitable for remote operations of various kinds of vehicles, and is also suitable for traveling on public roads and driving long distances. On the other hand, tablets are not always suitable for traveling on public roads or long-distance driving. The tablet can be used for short-distance driving of a vehicle in a limited area such as a parking lot, autonomous driving assistance such as emergency roadside evacuation, a remote operation of a small vehicle in a factory, and the like.

Terminal specification information SPC indicates specifications of the first external operator terminal 200E-X. For example, the terminal specification information SPC indicates a kind of the first external operator terminal 200E-X. The terminal specification information SPC may further indicate the kind of the mobility 100 that can be supported by the first external operator terminal 200E-X and the content of the remote operation that can be supported. The first external operator terminal 200E-X transmits the terminal specification information SPC to the management system 300. The management system 300 may register the terminal specification information SPC regarding the first external operator terminal 200E-X in the terminal management information MGT-T.

The assignment processing unit 400 recognizes a “requested terminal specification REQ-SPC” needed for the remote operation of the target mobility 100-X regarding each remote operation request REQ included in the remote operation request list REQ-LST. More specifically, the assignment processing unit 400 recognizes the requested terminal specification REQ-SPC needed for each remote operation request REQ based on at least one of the kind of the target mobility 100-X and the content of the remote operation of the target mobility 100-X. For example, the remote operation request REQ including at least one of the kind of the target mobility 100-X and the content of the remote operation of the target mobility 100-X is used as it is as the requested terminal specification REQ-SPC. As another example, a conversion table showing a correspondence between the remote operation request REQ and the requested terminal specification REQ-SPC may be prepared in advance, and the remote operation request REQ may be converted into the requested terminal specification REQ-SPC by using the conversion table.

The candidate extracting unit 410 acquires the terminal specification information SPC regarding the first external operator terminal 200E-X. For example, the candidate extracting unit 410 acquires the latest terminal specification information SPC from the first external operator terminal 200E-X. Alternatively, the candidate extracting unit 410 may acquire the previous terminal specification information SPC registered in the terminal management information MGT-T. The candidate extracting unit 410 recognizes at least one of the kind of the mobility 100 that can be supported by the first external operator terminal 200E-X and the content of the remote operation that can be supported based on the terminal specification information SPC. A conversion table may be prepared in advance for converting the terminal specification information SPC into the kind of the mobility 100 that can be supported and the content of the remote operation that can be supported, and the conversion table may be used. Additionally, the candidate extracting unit 410 acquires information on the requested terminal specification REQ-SPC regarding each remote operation request REQ included in the remote operation request list REQ-LST. Then, the candidate extracting unit 410 extracts, as a requestable candidate, the remote operation request REQ such that the requested terminal specification REQ-SPC is satisfied by the specifications of the first external operator terminal 200E-X. In other words, the candidate extracting unit 410 extracts, as a requestable candidate, a remote operation request REQ that can be supported by the specifications of the first external operator terminal 200E-X from the remote operation request list REQ-LST.

Combinations of the first and second aspects are also possible. That is, the candidate extracting unit 410 may extract, as a requestable candidate, the remote operation request REQ that can be supported by the license of the first external operator OE-X and the specifications of the first external operator terminal 200E-X from the remote operation request list REQ-LST.

A requestable candidate list LST includes one or more requestable candidates thus extracted. The requestable candidate list LST is presented to the first external operator OE-X. For this purpose, the assignment processing unit 400 transmits the requestable candidate list LST to the first external operator terminal 200E-X before assigning the first external operator OE-X to any of the remote operation requests REQ. The first external operator terminal 200E-X receives the requestable candidate list LST from the management system 300 and presents the requestable candidate list LST to the first external operator OE-X. For example, the first external operator terminal 200E-X displays the requestable candidate list LST on the display device 220.

The first external operator OE-X selects a desired remote operation request REQ from the presented requestable candidate list LST. For example, the first external operator OE-X uses the input device 230 to select the desired remote operation request REQ displayed on the display device 220. The remote operation request REQ selected by the first external operator OE-X is hereinafter referred to as a “selected remote operation request REQ-S”.

The first external operator terminal 200E-X transmits information on the selected remote operation request REQ-S to the management system 300. The assignment processing unit 400 receives the information on the selected remote operation request REQ-S transmitted from the first external operator terminal 200E-X. Then, the assignment processing unit 400 assigns the first external operator OE-X and the first external operator terminal 200E-X to the selected remote operation request REQ-S.

As described above, according to the present embodiment, the requestable candidate list LST is presented to the first external operator OE-X through the first external operator terminal 200E-X. In particular, before assigning the first external operator OE-X to the remote operation request REQ, the requestable candidate list LST is presented to the first external operator OE-X. The first external operator OE-X may select a desired remote operation request by himself/herself, from the requestable candidate list LST. Accordingly, the accuracy of the remote operation of the target mobility 100-X is secured.

The remote operation request REQ that can be supported by the license held by the first external operator OE-X may be extracted as the requestable candidate. The remote operation request REQ that cannot be supported by the first external operator OE-X is not presented to the first external operator OE-X, so that the first external operator OE-X can be prevented from erroneously selecting an inappropriate remote operation request REQ. This contributes to an efficient assignment process.

The remote operation request REQ that can be supported by the specifications of the first external operator terminal 200E-X may be extracted as the requestable candidate. The remote operation request REQ that cannot be supported by the first external operator terminal 200E-X is not presented to the first external operator OE-X, so that the first external operator OE-X can be prevented from erroneously selecting an inappropriate remote operation request REQ. This contributes to an efficient assignment process.

### 3-3. Example of Process Flow

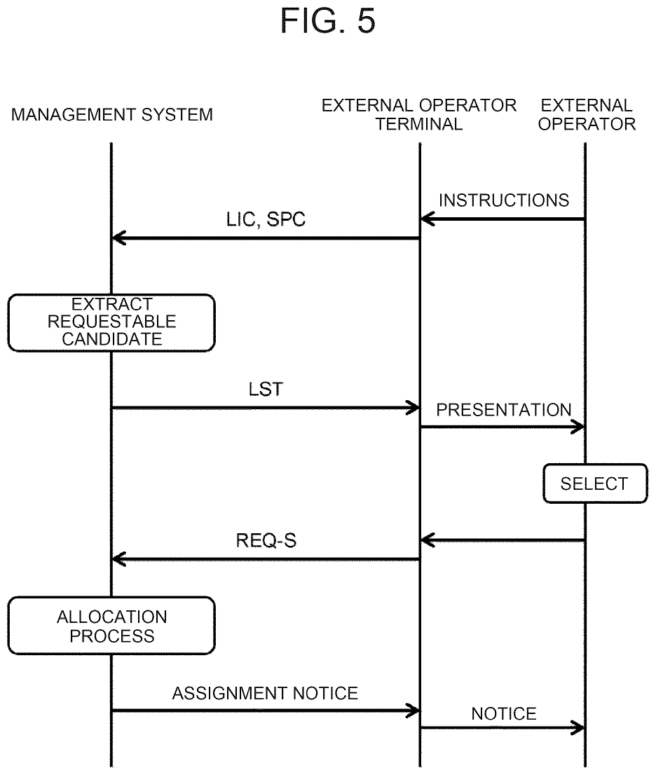

FIG. 5 is a diagram showing a first example of a process flow related to the external operator assignment process. First, the first external operator OE-X instructs the first external operator terminal 200E-X to transmit a job request. In response to the instruction from the first external operator OE-X, the first external operator terminal 200E-X transmits the job request to the management system 300. At this time, the first external operator terminal 200E-X may transmit the license information LIC regarding the first external operator OE-X and the terminal specification information SPC regarding the first external operator terminal 200E-X together with the job request.

The management system 300 receives the job request transmitted from the first external operator terminal 200E-X. In response to the job request, the management system 300 extracts, as a requestable candidate, the remote operation request REQ that can be supported by the first external operator OE-X and the first external operator terminal 200E-X from the remote operation request list REQ-LST. Before assigning the first external operator OE-X to any of the remote operation requests REQ, the management system 300 transmits the requestable candidate list LST including one or more requestable candidates to the first external operator terminal 200E-X.

The first external operator terminal 200E-X receives the requestable candidate list LST from the management system 300 and presents the requestable candidate list LST to the first external operator OE-X. For example, the first external operator terminal 200E-X displays the requestable candidate list LST on the display device 220. The first external operator OE-X selects a desired remote operation request REQ from the presented requestable candidate list LST. The first external operator terminal 200E-X transmits the information on the selected remote operation request REQ-S selected by the first external operator OE-X to the management system 300.

The management system 300 receives the information of the selected remote operation request REQ-S transmitted from the first external operator terminal 200E-X. Then, the management system 300 assigns the first external operator OE-X and the first external operator terminal 200E-X to the selected remote operation request REQ-S. The management system 300 transmits an assignment notification indicating an assignment result to the first external operator terminal 200E-X. The first external operator terminal 200E-X notifies the first external operator OE-X of the assignment result.

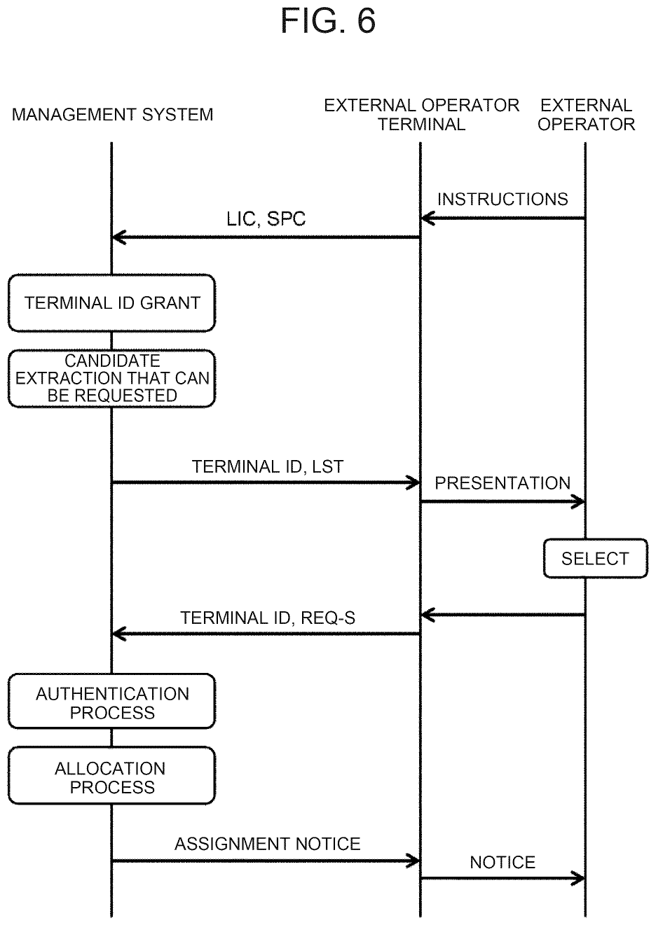

FIG. 6 is a diagram showing a second example of the process flow related to the external operator assignment process. Descriptions that overlap with the above-described first example will be omitted as appropriate.

When receiving a job request from the first external operator terminal 200E-X, the management system 300 applies a terminal ID (identification information) to the first external operator terminal 200E-X. The management system 300 transmits the terminal ID to the first external operator terminal 200E-X together with the requestable candidate list LST.

The first external operator terminal 200E-X transmits the terminal ID together with the information of the selected remote operation request REQ-S to the management system 300.

The management system 300 receives the terminal ID from the first external operator terminal 200E-X together with the information on the selected remote operation request REQ-S. The management system 300 authenticates the first external operator terminal 200E-X by collating the terminal ID applied to the first external operator terminal 200E-X by the management system 300 with the terminal ID received from the first external operator terminal 200E-X. In a case where the authentication is successful, the management system 300 assigns the first external operator OE-X and the first external operator terminal 200E-X to the selected remote operation request REQ-S.

According to the second example, since an authentication process is incorporated into the external operator assignment process, security is further improved.

What is claimed is:

1. A management system that is installed in a remote operation management center for managing a remote operation of a mobility, in which a remote operator outside the remote operation management center is an external operator, and a remote operator terminal configured to be used by the external operator for the remote operation is an external operator terminal, the management system comprising:
one or more processors; and
one or more storage devices configured to store a remote operation request list including one or more remote operation requests,
wherein the one or more processors are configured to
acquire at least one of license information indicating a license held by the external operator and terminal specification information indicating a specification of the external operator terminal,
extract, as a requestable candidate, a remote operation request that is supportable by at least one of the license of the external operator and the specification of the external operator terminal from the remote operation request list, and
transmit information on one or more requestable candidates to the external operator terminal before the external operator is assigned to any of the remote operation requests.

2. The management system according to claim 1, wherein the one or more processors are further configured to
receive, from the external operator terminal, information on a selected remote operation request selected by the external operator from among the one or more requestable candidates, and
assign the external operator and the external operator terminal to the selected remote operation request.

3. The management system according to claim 2, wherein the one or more processors are further configured to
apply identification information to the external operator terminal,
transmit the identification information along with the information on the one or more requestable candidates to the external operator terminal,
receive the identification information along with the information on the selected remote operation request from the external operator terminal,
authenticate the external operator terminal based on the identification information received from the external operator terminal, and
assign the external operator and the external operator terminal to the selected remote operation request in a case where the external operator terminal is successfully authenticated.

4. The management system according to claim 1, wherein:
each of the one or more remote operation requests includes at least one of a kind of a target mobility and a content of the remote operation of the target mobility; and
the one or more processors are further configured to
recognize a requested terminal specification requested for each of the remote operation requests based on at least one of the kind of the target mobility and the content of the remote operation of the target mobility, and
extract, as the requestable candidate, a remote operation request such that the requested terminal specification is satisfied by the specification of the external operator terminal.

5. The management system according to claim 1, wherein:
each of the one or more remote operation requests includes at least a kind of a target mobility; and
the one or more processors are further configured to
recognize a requested license requested for each of the remote operation requests based on the kind of the target mobility, and
extract, as the requestable candidate, a remote operation request such that the requested license is included in the license of the external operator.
